(19) United States
(12) Patent Application Publication
(10) Pub. No.: US 2025/0376410 A1
(43) Pub. Date: Dec. 11, 2025

(54) POSITIONING AID AND METHOD FOR PRODUCING A HOLLOW-CORE FIBER AND A PREFORM THEREFOR USING THE POSITIONING AID

(71) Applicant: Heraeus Quarzglas GmbH & Co. KG, Hanau (DE)

(72) Inventors: Manuel ROSENBERGER, Kleinostheim (DE); Jaqueline PLASS, Kleinostheim (DE); Yusuf TANSEL, Kleinostheim (DE); Jörg WERNER, Kleinostheim (DE); Andreas MÜLLER, Kleinostheim (DE); Kay SCHUSTER, Bitterfeld-Wolfen (DE)

(21) Appl. No.: 19/225,658

(22) Filed: Jun. 2, 2025

(30) Foreign Application Priority Data
Jun. 6, 2024 (EP) 24180451.7

(51) Int. Cl. C03B 37/027; C03B 37/012

(52) U.S. Cl. CPC C03B 37/02736; C03B 37/0122; C03B 37/02781; C03B 2203/16

(57) ABSTRACT

A method for producing a preform for an antiresonant hollow-core fiber involves providing a cladding tube comprising a cladding tube inner bore with a cladding tube inside and a central cladding tube axis, providing a plurality of tubular antiresonance element preforms (ARE preforms for short), each comprising a longitudinal tube axis and an outer tube surface, initially positioning the ARE preforms in peripheral desired positions of the cladding tube inner side by means of a positioning aid to form a primary preform, and thermally stretching the primary preform to form the hollow-core fiber or further processing the primary preform to form a secondary preform from which the hollow-core fiber is drawn.

### CROSS-REFERENCE TO RELATED APPLICATION

This application claims priority pursuant to 35 U.S.C. 119 (a) to European Patent Office No. 24180451.7, filed Jun. 6, 2024, which application is incorporated herein by reference in its entirety.

### BACKGROUND

The invention relates to the field of optical fiber technology and in particular to the field of antiresonant hollow-core fibers (abbreviated as ARHCF). The hollow core region is surrounded by an inner cladding region in which so-called “antiresonant elements” (or antiresonance elements, abbreviated as “AREs”) are arranged. The walls, evenly distributed around the hollow core, of the ARE's can reflect the incident light and guide it through the fiber core. Hollow-core fibers therefore allow light to be guided within a “hollow” core that is either evacuated or filled with a gas (such as air).

This fiber technology promises low optical attenuation, a very broad transmission spectrum (even in the UV or IR wavelength ranges), and low latency period during data transmission. In addition, these fibers are suitable for spectroscopic applications as well as for the transmission of short laser pulses for high-power beam guidance, e.g., for material processing, modal filtering, nonlinear optics, in particular for supercontinuum generation, from the ultraviolet to the infrared wavelength range.

### SUMMARY OF INVENTION

A known method for producing a preform for an antiresonant hollow-core fiber involves providing a cladding tube comprising a cladding tube inner bore with a cladding tube inside and a central cladding tube axis, providing a plurality of tubular antiresonance element preforms (ARE preforms for short), each comprising a longitudinal tube axis and an outer tube surface, initially positioning the ARE preforms in peripheral desired positions of the cladding tube inner side by means of a positioning aid to form a primary preform, and thermally stretching the primary preform to form the hollow-core fiber or further processing the primary preform to form a secondary preform from which the hollow-core fiber is drawn. Proceeding therefrom, in order to allow the ARE preforms to be positioned as precisely as possible in predetermined azimuthal positions of the cladding tube, it is proposed to use a positioning aid which is equipped with adjusting means which allow at least some of the ARE preforms to be repositioned in a different position than their initial position. In particular, the invention relates to a method for producing an antiresonant hollow-core fiber, which comprises a hollow core extending along a fiber longitudinal axis and an inner cladding region that surrounds the hollow core and comprises a plurality of antiresonance elements, said method comprising the method steps of:
(a) providing a cladding tube comprising a cladding tube inner bore with a cladding tube inside and a cladding tube center axis,
(b) providing a plurality of tubular ARE preforms (abbreviated as ARE preforms), each comprising a longitudinal tube axis and an outer tube surface,
(c) initially positioning the plurality of ARE preforms in peripheral desired positions on the inside of the cladding tube by means of a positioning aid to form a primary preform,
(d) thermally stretching the primary preform to form the hollow-core fiber or further processing the primary preform to form a secondary preform from which the hollow-core fiber is drawn.

In addition, the invention also relates to a method for fabricating a preform for an antiresonant hollow-core fiber which comprises a hollow core extending along a longitudinal axis of the fiber and a cladding region that surrounds the hollow core and comprises a plurality of antiresonance elements, comprising the method steps of:
(a) providing a cladding tube comprising a cladding tube inner bore with a cladding tube inside and a cladding tube center axis,
(b) providing a plurality of tubular ARE preforms, each comprising a longitudinal tube axis and an outer tube surface,
(c) initially positioning the plurality of ARE preforms in peripheral desired positions on the inside of the cladding tube by means of a positioning aid to form a primary preform,
(d) optionally further processing the primary preform to form a secondary preform.

Furthermore, the invention relates to a positioning aid for use in the production of an antiresonant hollow-core fiber or a preform for an antiresonant hollow-core fiber, which aid has at least a first adjusting means for initially positioning at least one inner tube on an inside of at least one outer tube.

### BRIEF SUMMARY

Antiresonant hollow-core fibers are usually drawn from preforms. In the preform, the AREs are designed as starting components or as starting structures, which are collectively referred to here as “ARE preforms.” These are distributed around the inside of a cladding tube. In the simplest case, the ARE preforms are designed as tubes (or capillaries). Other ARE preforms are composed of a plurality of tubes nested with each other. For example, a preform for a hollow-core fiber comprising the so-called NANF design (nested antiresonant nodeless hollow-core fibers) contains a plurality of ARE preforms, in the simplest case each consisting of an outer tube (hereafter also called a “primary tube”) and an inner tube (hereafter also called a “secondary tube”) that is arranged on the inside of the primary tube. In a DNANF design (Double Nested Antiresonant Nodeless Hollow Core Fibers), an additional inner tube, which can also be referred to as a “tertiary tube,” is arranged in the secondary tube. The secondary and tertiary tubes form additional hollow channels in the hollow core fiber, which contribute to reducing optical fiber attenuation by causing multiple radial reflections and avoiding transitions or nodes that cause resonances.

In the single nested ANF design and the double nested ANF design, the contact point of the secondary tube is located on the inside of the primary tube, and the contact point of the tertiary tube is located on the inside of the secondary tube, respectively, in each case at the same azimuthal position (around the cladding tube lateral surface) as the contact point between the primary tube and the cladding tube. In contrast, in the so-called “ALIF” (antiresonant leakage inhibited fibers) design, a pair of secondary tubes are inserted into the inside of the primary tube, which are spaced apart from one another and attached at azimuthal locations around the circumference of the primary tube, both being offset from the peripheral contact point of the primary tube on the cladding tube. There is therefore an open gap between each pair of secondary tubes in radial direction.

The cylindrical starting components that form an ARE preform (i.e., the primary, secondary and tertiary tubes, for example), and thus also each ARE preform, deviate from the specified target geometry to a certain extent. Each step of positioning and forming inevitably leads to further geometric deviations, which can add up to an absolute geometric error in the preform. This places great demands on the accuracy with which the starting components are positioned and fixed in their respective target positions, in particular in the case of compact arrangements, such as with the DNANF or the ALIF design.

A plurality of positioning aids have been proposed in order to improve positioning accuracy, such as spacers and positioning templates. In WO 2019/053412 A1, the primary tubes are positioned in predefined peripheral locations on the inside of the cladding tube using spacer elements, each of which is in contact with two adjacent primary tubes. The inside of the cladding tube can be shaped by mechanical processing such that the spacer elements project radially inward from the inside.

Structuring the cladding tube inner wall to create spacer elements is time-consuming. In EP 3 766 847 A1, the use of a positioning template is proposed for arranging the ARE preforms on the inside of the cladding tube, which has holding elements for positioning the ARE preforms in the desired positions. The positioning template is inserted into the inner bore of the cladding tube at one end or both ends.

JP 2018150184 A discloses another method for producing hollow-core fibers comprising the NANF design, in which a plurality of ARE preforms are provided, which are composed of nested starting components, each with a primary tube and a secondary tube. To arrange the ARE preforms on the inside of a cladding tube, a cylindrical glass template is welded to both ends of the cladding tube. This ensures a certain degree of axial guidance of the ARE preforms. The cylinder is divided into two parts in the direction of its longitudinal axis, with bores for receiving the primary tubes being provided in the front part thereof facing the cladding tube end face, and bores for receiving the secondary tubes being provided in the rear part. The position of the primary tubes can be further stabilized by inserting a cylindrical inner insert into the cladding tube inner bore, which has a gear-like outer contour adapted to the inner contour of the primary tube arrangement.

### Technical Problem

In order to comply with resonance or antiresonance conditions, even small dimensional and positional deviations of the order of magnitude of the working wavelength of the light to be guided are not tolerable.

One object of the invention is therefore to specify a method for producing an antiresonant hollow-core fiber with which high precision of the antiresonance elements in the hollow-core fiber can be reproducibly achieved. In particular, the aim is to allow the ARE preforms to be positioned as precisely as possible in specified azimuthal positions of the cladding tube.

Furthermore, the object of the invention is to specify a method for producing a preform, from which an antiresonant hollow-core fiber with antiresonance elements that are positioned as precisely as possible can be reproducibly drawn.

Furthermore, the object of the invention is to provide a positioning aid that allows ARE preforms to be positioned as precisely as possible in a primary preform.

With regard to the method for producing the antiresonant hollow-core fiber, this object is achieved by a method having the features of claim 1.

Proceeding from a method for producing the hollow-core fiber according to the type mentioned at the outset, the measure for initially positioning the ARE preforms at peripheral desired positions on the inside of the cladding tube is supplemented by using a positioning aid equipped with adjusting means that allow at least some of the ARE preforms to be repositioned in a different position from their initial position.

The starting point for the production of the antiresonant hollow-core fiber is a preform, which is referred to here as a “primary preform.” The production of the primary preform usually involves the installation of ARE preforms and their arrangement with—and optionally local connection to—the inside of the cladding tube.

In the prior art, a rigid template is used to initially position the ARE preforms in peripheral target positions on the inside of the cladding tube. Due to dimensional tolerances in both the template and the ARE preforms, the resulting primary preform often contains unwanted clearances and gaps. For example, a gap between the inside of the cladding tube and the ARE preform reduces or prevents contact between these components. This results in locally undefined directions of the surface tension during the subsequent thermal stretching of the primary preform and associated unwanted, asymmetrical deformations, which can lead to partial or complete loss of the preform.

This applies equally to starting components of nested ARE preforms, such as a lack of contact between the inside of the primary tube and a secondary tube arranged therein, or a lack of contact between the inside of the secondary tube and a tertiary tube arranged therein. Thus, when an ARE outer tube rests against the cladding tube from the beginning, different deformation results than when an ARE outer tube is only melted onto the cladding tube at a later point during the thermal stretching process.

In order to avoid this disadvantage wherever possible, the positioning aid of the invention allows for repositioning, by means of which, after the ARE preform has been initially positioned, a further change in its spatial position is possible. The positioning aid of the invention is equipped with “adjustable adjusting means” in this respect. The adjustable adjusting means not only serves to better fix the ARE preform after it has been initially positioned, but also allows for a further change to its spatial position. The spatial position is changed, for example, by displacing the ARE preform. The spatial “displacement” of individual ARE preforms—especially transversely to each longitudinal tube axis—is also referred to hereinafter as the “fine adjustment” of an ARE preform. By means of this fine adjustment, some of the ARE preforms and preferably all of the ARE preforms of the primary preform can be moved as precisely as possible to their target positions within the cladding tube inner bore, even if it was not precisely positioned during the initial positioning process.

In the case of ARE preforms with nested starting components consisting of a primary tube and at least one secondary tube, the fine adjustment involves displacing the spatial position of at least the primary tube and preferably also displacing at least one of the secondary tubes within the primary tube inner bore.

In the case of ARE preforms with nested starting components consisting of a primary tube, at least one secondary tube and at least one tertiary tube, the fine adjustment preferably also involves displacing the spatial position of at least one of the tertiary tubes within the secondary tube inner bore.

Due to the opportunity to make fine adjustments, the positioning aid is not rigid as in the prior art, but it can be flexibly or variably adapted to the spatial conditions. This allows dimensional deviations of the positioning aid, the cladding tube, the ARE preforms and, if applicable, their starting components to be compensated for. In particular, the fine adjustment can close unwanted clearances and gaps between the cladding tube and ARE preforms and, if applicable, between their starting components. The creation of contact between the cladding tube and the ARE preforms, which is in itself desired but is not provided, achieves during subsequent thermal stretching of the primary preform the most defined, symmetrical spatial distributions of the direction of the surface tension possible, thus avoiding unintentional deformations. In the case of nested ARE preforms, this applies equally to the contact between the inside of the primary tube and at least one secondary tube, and, where applicable, to the contact between the inside of a secondary tube and at least one tertiary tube.

The positioning aid is arranged at one front-end of the cladding tube, but advantageously at both front-ends.

In a preferred method, the ARE preform is moved in a direction transverse to its longitudinal tube axis when it is repositioned.

Fixing and changing the spatial position of the ARE preform or of its starting components advantageously involves a displacement transverse to the longitudinal axis of the tube of the ARE preform. For example, “transverse” means a displacement caused by the action of a force that has a directional component that forms an angle of 45 to 135 degrees with the longitudinal axis of the tube. An included angle of 90 degrees is particularly effective, with the displacement force acting in a direction that is perpendicular to the longitudinal axis of the tube.

The displacement is particularly effective when the repositioning is brought about by a force acting on the ARE preform that includes a directional component perpendicular to the longitudinal cladding tube axis and a directional component directed radially outward.

In a further advantageous method, the positioning aid has a longitudinal axis and an outer side, and the adjusting means comprises a plurality of receptacles, into each of which an end of the ARE preform projects or through which an ARE preform extends, wherein the adjusting means also comprises transverse bores which each run from the outer side of the positioning aid to one of the receptacles and through which a pressure element extends to the outer tube surface of the ARE preform or of its starting components.

For example, the plurality of receptacles have a cylindrical inner contour that is adapted to the outer contour of the ARE preforms. One end of an ARE preform protrudes into each of these receptacles or an ARE preform extends through the receptacle. This substantially corresponds to the initial positioning method known in the art. In contrast, the adjusting means of the invention preferably also comprises transverse bores which extend from the outer side of the positioning aid to each of the receptacles. The transverse bores comprise a uniform cross section or comprise a cross section that tapers from the outside to the inside. The taper can be designed as a gradual reduction in the cross section.

A pressure element, such as a set screw, extends through the transverse bore, wherein the transverse bores may be at least partially formed as threaded bores. The pressure element can rest on the outer tube surface of the ARE preform or can be pressed against the outer tube surface of the ARE preform. By pressing the pressure element against the outer tube surface of the ARE preform, a force is generated that can cause the ARE preform to be displaced. This procedure corresponds to the “repositioning” or “fine adjustment” procedure explained above. The pressure element is designed in one piece or consists of a plurality of components that interact with one another, such as a set screw that acts on a piston that can move axially in the transverse bores.

In the case of a nested ARE preform comprising a plurality of tubular starting components, a positioning aid is preferably used which has adjusting means for repositioning all the tubular starting components of the ARE preform. Corresponding receptacles, transverse bores and pressure elements are provided for all the tubular starting components.

Preferably, all of the transverse bores extend from an outer side of the positioning aid to each receptacle and—relative to the longitudinal positioning aid axis—in the radial direction. At least some of the transverse bores can intersect the longitudinal positioning aid axis. As a result, the displacement force acting on each ARE preform has a directional component that acts completely or at least partially in the radial direction and that displaces the ARE preform—and if applicable a starting component thereof—outward toward the inside of the cladding tube. In this way, insufficient contact between the cladding tube and the ARE preform or between the starting components thereof can be established or improved.

Preferably, the receptacles are slightly oversized so that a certain amount of mechanical play remains for finely adjusting the ARE preforms. In this regard, the receptacles advantageously have an oval or, particularly preferably, an elongated hole cross section, with a long major axis and a short major axis, wherein the long major axis extends radially to the longitudinal positioning aid axis.

The larger the length ratio of the long major axis to the short major axis, the greater the maximum available displacement distance in general. This length ratio is preferably in the range of 1.01 to 1.3.

In an advantageous method, a positioning aid is used which is designed to position a number “n” of ARE preforms and which has at least one flat side in cross section and preferably has a polygonal outer contour in cross section comprising a number “N” of flat sides, where N=n or N=2n if “n” is an even number, and where N=2n if “n” is an odd number greater than 1.

The outer contour can be partially or completely composed of flat sides. The at least one flat side extends in parallel with the longitudinal axis of the positioning aid and forms at least part of its outer side. A single flat side is sufficient to facilitate the alignment of positioning templates with respect to one another, which templates are used at both ends of the cladding tube. The at least one flat side also simplifies the creation of transverse bores that begin at the flat side and each extend to one of the receptacles for an ARE preform or a starting component thereof. The surface normal of each of the flat sides extends in parallel with the direction of the transverse bore, simplifying its creation.

It has proven advantageous if the positioning aid and the cladding tube are axially spaced apart from one another.

Contact or fixation can cause the longitudinal axes of the positioning aid and the cladding tube to tilt relative to one another, which is avoided by their being spaced apart. A very small axial distance of, for example, 0.1 mm is sufficient for this. For very large distances of, for example, more than 500 mm, other handling disadvantages prevail.

After the ARE preforms have been positioned using the positioning aid, they are advantageously additionally fixed in this position, preferably by creating an integral bond. An integral bond can be achieved, for example, by locally welding the primary tube to the inside of the cladding tube, or, in the case of nested ARE preforms, by locally welding the secondary tube to the inside of the primary tube or the tertiary tube to the inside of the secondary tube. The position is advantageously fixed at both ends of the ARE preform.

With regard to the method for producing a preform for an antiresonant hollow-core fiber, the aforementioned object is achieved by a method according to claim 10.

Proceeding from a method for producing the hollow-core fiber according to the type mentioned at the outset, the measure for initially positioning the ARE preforms at peripheral desired positions on the inside of the cladding tube is supplemented by using a positioning aid equipped with adjusting means that allow at least some of the ARE preforms to be repositioned in a different position from their initial position.

When producing the preform for an antiresonant hollow-core fiber, a “primary preform” is first created. The production of the primary preform usually involves the installation of ARE preforms and their arrangement with—and optionally local connection to—the inside of the cladding tube.

The positioning aid according to the invention is equipped with “adjustable adjusting means” which, after the ARE preform has been initially positioned, allow for a further change to its spatial position. The adjustable adjusting means makes it possible to further change the spatial position of the ARE preform after it has been initially positioned. The spatial position is changed, for example, by displacing the ARE preform. The spatial “displacement” of individual ARE preforms—in particular transversely to each tube longitudinal axis (“fine adjustment”).

By means of fine adjustment, the ARE preform, and preferably all of the ARE preforms of the primary preform, can be moved as precisely as possible to their desired positions within the cladding tube inner bore, even if it was not precisely positioned during the initial positioning process.

In the case of ARE preforms with nested starting components consisting of a primary tube and at least one secondary tube, the fine adjustment involves displacing the spatial position of at least the primary tube and preferably also displacing at least one of the secondary tubes within the primary tube inner bore.

In the case of ARE preforms with nested starting components consisting of a primary tube, at least one secondary tube and at least one tertiary tube, the fine adjustment preferably also involves displacing the spatial position of at least one of the tertiary tubes within the secondary tube inner bore.

Due to the opportunity to make fine adjustments, the positioning aid is not rigid as in the prior art, but it can be flexibly or variably adapted to the spatial conditions. This allows dimensional deviations of the positioning aid, the cladding tube, the ARE preforms and, if applicable, their starting components to be compensated for. In particular, the fine adjustment can close unwanted clearances and gaps between the cladding tube and ARE preforms and, if applicable, between their starting components. The creation of contact between the cladding tube and the ARE preforms, which is in itself desired but is not provided, achieves, during subsequent thermal stretching of the primary preform, the most defined, symmetrical spatial distributions of the direction of the surface tension possible, thus avoiding unintentional deformations. In the case of nested ARE preforms, this applies equally to the contact between the inside of the primary tube and at least one secondary tube, and, where applicable, to the contact between the inside of a secondary tube and at least one tertiary tube.

The positioning aid is arranged at one front-end of the cladding tube, but advantageously at both front-ends.

Measures for producing the preform are explained above in connection with the production of the hollow-core fiber, and these explanations are hereby incorporated.

With regard to the positioning aid, the above-mentioned object is achieved by a positioning aid having the features of claim 11.

In particular, the positioning aid is characterized in that it is equipped with at least one second adjusting means which allows repositioning, which is changed with respect to the initial positioning, of the at least one inner tube.

In the prior art, a rigid template is used for initially positioning inner tubes in peripheral desired positions of an outer tube. Due to dimensional tolerances in the template and the inner and outer tubes, this initial positioning often results in unwanted clearances and gaps. For example, a gap between the inside of the outer tube and the inner tube reduces or prevents contact between these components. When subsequently thermally stretching the ensemble consisting of the outer tube and inner tube, this results in a locally undefined direction of the surface tension and associated unwanted asymmetrical deformations, which can lead to the partial or complete loss of the elongated component. This applies, for example, to starting components of nested ARE preforms, such as a lack of contact between the inside of the primary tube and a secondary tube arranged therein, or a lack of contact between the inside of the secondary tube and a tertiary tube arranged therein. Thus, when an ARE outer tube rests against the cladding tube from the beginning, different deformation results than when an ARE outer tube is only melted onto the cladding tube at a later point during the thermal stretching process.

In order to avoid this disadvantage wherever possible, the positioning aid according to the invention allows for repositioning, by means of which, after the at least one inner tube has been initially positioned, its spatial position can be changed further. The positioning aid according to the invention is equipped with at least one “adjustable adjusting means” in this regard. The adjustable adjusting means makes it possible to further change the spatial position of the inner tube after it has been initially positioned. The change in spatial position is brought about, for example, by displacing the inner tube, which is also referred to here as a “fine adjustment” of the inner tube. By means of this fine adjustment, the at least one inner tube, and preferably all the inner tubes of a component ensemble, can be moved as precisely as possible to their desired positions within the outer tube inner bore, even if it was not precisely positioned during the initial positioning process.

Due to the opportunity to make fine adjustments, the positioning aid is not rigid as in the prior art, but it can be flexibly or variably adapted to the spatial conditions. This allows compensation for dimensional deviations of the positioning aid, the outer tube, the at least one inner tube and, if applicable, other starting components. In particular, the fine adjustment can close unwanted clearances and gaps between the outer tube and inner tube and, if applicable, between other starting components. The creation of contact between the outer tube and the at least one inner tube, which is in itself desired but is not existent, achieves, during subsequent thermal stretching, the most temporally and spatially defined direction of the surface tension possible, thus avoiding unintentional deformations.

The positioning aid is made of metal, ceramic, glass or graphite, for example. It is designed for arrangement on one of the front-ends of the outer tube, but advantageously on both front-ends of the outer tube. It can be made from one part or it can be composed of a plurality of pieces. The positioning aid can be used, for example, for positioning and finely adjusting ARE preforms on the inside of a cladding tube, wherein, in this case, the ARE preforms represent “inner tubes” and the cladding tube represents an “outer tube.”

The positioning aid can also be used for positioning and finely adjusting ARE preforms with nested starting components consisting of a primary tube and at least one secondary tube, wherein the fine adjustment relates to the displacement of the spatial position of at least one of the secondary tubes within the primary tube inner bore. In this case, the primary pipe represents an “outer pipe” and the at least one secondary pipe represents an “inner pipe”.

The positioning aid can also be used for positioning and finely adjusting ARE preforms with nested starting components consisting of a primary tube, at least one secondary tube and at least one tertiary tube, wherein the fine adjustment preferably also involves displacing the spatial position of at least one of the tertiary tubes within the secondary tube inner bore. In this case, the primary tube represents an “outer tube” and the tertiary tube represents an “inner tube,” and the at least one secondary tube is an “inner tube” with respect to the primary tube and is an “outer tube” with respect to the tertiary tube.

The change in the spatial position of the inner tube is advantageously achieved by displacing it transversely to the longitudinal axis of the inner tube. For example, “transverse” means a displacement caused by the action of a force that has a directional component that forms an angle of 45 to 135 degrees with the longitudinal axis of the tube. An included angle of 90 degrees is particularly effective, with the displacement force acting in a direction that is perpendicular to the longitudinal axis of the tube.

In an advantageous embodiment, the positioning aid has a longitudinal axis and an outer side, wherein the at least one first adjusting means comprises a receptacle for the inner tube, and wherein the at least one second adjusting means has a transverse bore which extends from the outer side of the positioning aid to the receptacle and through which a pressure element extends.

The at least one receptacle has, for example, a cylindrical inner contour that is adapted to the outer contour of the inner tube. One end of the inner tube protrudes into the receptacle, or the inner tube extends through the receptacle. This substantially corresponds to the positioning aids known from the prior art used for the initial positioning process. In contrast, the positioning aid according to the invention preferably also comprises transverse bores which extend from the outer side of the positioning aid to each of the receptacles. The transverse bores have a uniform cross section or have a cross section that tapers from the outside to the inside. The taper can be designed as a gradual reduction in the cross section.

A pressure element, such as a screw, extends through the transverse bore, wherein the transverse bore may be at least partially formed as a threaded bore. The pressure element can rest on the outer tube surface of the ARE preform or can be pressed against the outer tube surface of the ARE preform. By pressing the pressure element against the outer tube surface of the ARE preform, a force is generated that can cause the ARE preform to be displaced. This procedure corresponds to the “repositioning” or “fine adjustment” procedure explained above. The pressure element is designed in one piece or consists of a plurality of components that interact with one another, such as a set screw that acts on a piston that can move axially in the transverse bores.

As already explained above, the positioning aid can be used for positioning and finely adjusting the tubular starting components of a nested ARE preform, i.e., the primary tube, at least one secondary tube and, if applicable, at least one tertiary tube. The positioning aid comprises adjusting means for repositioning all the tubular starting components of the ARE preform. In particular, corresponding receptacles, transverse bores and pressure elements are provided for all the tubular starting components. The transverse bores extend from an outer side of the positioning aid to each of the receptacles. They preferably intersect the longitudinal axis of the positioning aid. As a result, the displacement force acting on each inner tube (secondary tube or tertiary tube) has a directional component that acts completely or at least partially in a radial direction, which displaces the inner tube toward the inside of the outer tube (primary tube or secondary tube). This can create or improve insufficient contacts between the outer tube and inner tube.

Preferably, the receptacles are slightly oversized so that a certain amount of mechanical play remains for finely adjusting the at least one inner tube. In this regard, the receptacles advantageously have an oval cross section, and particularly preferably an elongated hole cross section, with a long major axis and a short major axis, wherein the long major axis extends radially with respect to the longitudinal positioning aid axis.

The larger the length ratio of the long major axis to the short major axis, the greater the maximum available displacement distance in general. This length ratio is preferably in the range of 1.01 to 1.3.

In an advantageous embodiment, the positioning aid is designed for positioning a number “n” of ARE preforms on the inside of a cladding tube and has at least one flat side in cross section, wherein it preferably has a polygonal outer contour in cross section with a number “N” of flat sides, where N=n or N=2n if “n” is an even number, and where N=2n if “n” is an odd number greater than 1.

The outer contour can be partially or completely composed of flat sides. The at least one flat side extends in parallel with the longitudinal axis of the positioning aid and forms at least part of its outer side. A single flat side is sufficient to facilitate the alignment of positioning templates with respect to one another, which templates are used at both ends of the cladding tube. The at least one flat side also simplifies the creation of transverse bores that begin at the flat side and each extend to one of the receptacles for an ARE preform or a starting component thereof. The surface normal of each of the flat sides extends in parallel with the direction of the transverse bore, simplifying its creation.

### Definitions

Individual method steps and terms of the above description are further defined below. The definitions are part of the description of the invention. In the event of a substantive inconsistency between one of the following definitions and the rest of the description, the statements made elsewhere in the description take precedence.

For terms and measurement methods that are not specifically defined in the description, the interpretation according to the International Telecommunication Union (ITU) shall apply. Where no measurement method is specified for a parameter, the standard measurement method shall be used for that parameter and, in particular, the measurement method laid down in the relevant ISO standard whose publication date is closest to that of the present application. Should measurement conditions not have been specified, the standard conditions (SATP conditions) for the temperature will be 298.15 K (25° C., 77° F.) and for the absolute pressure 100 kPa (14.504 psi, 0.986 atm).

### Antiresonance Elements

Antiresonance elements can be simple or interleaved structural elements of the hollow-core fiber. They comprise at least two walls which, viewed from the direction of the hollow core, have a negative curvature (convex) or no curvature (flat, straight). They generally consist of a material that is transparent to the working light, e.g., glass, in particular doped or non-doped SiO₂, a plastics material, in particular a polymer, a composite material, or a crystalline material.

### ARE Preform

ARE preforms are the components of the preform that are inserted into the cladding tube inner bore and arranged on the inside of the cladding tube. They are substantially formed into antiresonance elements in the hollow-core fiber by being thermally stretched during the fiber drawing process and form the inner cladding region of the hollow-core fiber. Nested ARE preforms form nested antiresonance elements in the hollow-core fiber. They are composed of a plurality of starting components, specifically a primary tube and at least one additional cylindrical starting component that is arranged in the inner bore of the primary tube. The at least one additional starting component can be at least one additional tube that rests against the inner lateral surface of the primary tube. The additional tube is referred to as a “nested element” or a “secondary tube.” For a plurality of nested ARE preforms, at least one additional starting component can be arranged in the inner bore of the secondary tube—for example, a third tube resting against the inner lateral surface of the nested secondary tube, which is referred to here as the “tertiary tube.” Nested ARE preforms are also referred to here as “ARE preforms” for short.

In nested ARE preforms, the starting components—i.e., the primary tube, at least one secondary tube and, if applicable, at least one tertiary tube—form a loose ensemble, or they are available as a prefabricated ARE preform, i.e., a self-supporting structure in which the at least one secondary tube is welded to the inside of the primary tube and, if applicable, the at least one tertiary tube is welded to the inside of the secondary tube such that these starting components can be handled together.

### Preform/Primary Preform/Secondary Preform/Core Preform (Cane)

The preform is the component from which the anti-resonant hollow-core fiber is drawn. It is a primary preform or a secondary preform generated by further processing the primary preform. The primary preform can be in the form of a unit consisting of at least one cladding tube and ARE preforms loosely received therein or ARE preforms immovably fixed therein. The ARE preforms can be prefabricated.

Further processing the primary preform into a secondary preform from which the hollow-core fiber is drawn may comprise a single or repeated performance of one or more of the following hot-forming processes:
(i) thermal stretching,
(ii) collapse,
(iii) collapse and simultaneous thermal stretching,
(iv) collapse of additional cladding material,
(v) collapse of additional cladding material and subsequent thermal stretching,
(vi) collapse of additional cladding material and simultaneous thermal stretching.

In the literature, a cane is a preform that is obtained by collapsing and/or thermally stretching a primary preform and thus falls under the definition of the secondary preform. Typically, it is covered with additional casing material before or during drawing of the hollow-core fiber.

### Prefabricated ARE Preform

It is a self-supporting, handleable structure that contains a primary tube and at least one secondary tube that is rigidly connected to the inside of the primary tube. At least one additional inner tube—a tertiary tube—can be fixed to the inside of the secondary tube.

### Long Major Axis/Short Major Axis

The “long major axis” is referred to as the longest cross-sectional axis and the “short major axis” is referred to as the shortest cross-sectional axis of an oval cross section or of an elongated hole cross section. In the case of an elliptical cross section, the long major axis corresponds to the large half-axis, and the short major axis corresponds to the small half-axis. For an elongated hole, the long major axis corresponds to the elongated hole distance (the length of the elongated hole), and the short major axis corresponds to the width of the elongated hole.

### Thermal Stretching/Collapsing/Elongation Ratio

The arrangement of the primary tube, one or more secondary tubes, one or more tertiary tubes, or the primary preform is thermally stretched (elongated). The stretching can take place without simultaneous collapse. Thermal stretching can be done true to scale so that, for example, the shape and arrangement of components or elements of the primary preform are reflected in the stretched elongated end product. During thermal stretching, however, the primary preform may also not be drawn to scale and its geometry may be changed.

In the collapse process, an inner bore is narrowed or annular gaps between the tubular component are closed or narrowed. The collapse process is usually accompanied by thermal stretching.

The elongation ratio is calculated in this regard as the ratio of the component lengths before and after thermal stretching.

### Hollow Core/Inner Casing Region/Outer Shell Region

The unit consisting of the cladding tube and the loosely accommodated or firmly fastened joined assembly is also referred to here as the “primary preform”. The primary preform comprises the hollow core and a casing region. This casing region is also referred to as an “inner casing region” when there is also an “outer casing region” that has been produced, for example, by collapse onto the primary preform and if a distinction is to be made between these casing regions. The designations “inner casing region” and “outer casing region” are also used for the corresponding regions in the hollow-core fiber or in intermediate products which are obtained by further processing of the primary preform.

### Cross Section/Inner Bore

The term “cross section” in connection with elongated ARE preforms and their cylindrical starting components always denotes the cross section perpendicularly to each longitudinal axis and specifically, unless stated otherwise, the cross section of the outer contour (not the cross section of the inner contour), of tubular components.

The designation “tube inner face” is also used as a synonym for “tube inner lateral surface,” and the designation “tube outer face” is also used as a synonym for “tube outer lateral surface.” The term “inner bore” in conjunction with a tube does not indicate that the inner bore has been produced by a drilling process.

### BRIEF DESCRIPTION OF THE DRAWINGS

The invention is explained in more detail below with reference to an exemplary embodiment and a drawing. In detail, in a schematic representation,

FIG. 1 shows an exploded view of positioning aids, a cladding tube and starting components of nested ARE preforms for producing a primary preform and a side view of an assembly drawing;

FIG. 2 shows a cross section of a secondary preform for a hollow-core fiber comprising a NANF design, comprising a cladding tube and nested ARE preforms;

FIG. 3 shows a longitudinal section of a positioning aid for use in the production of the preform in FIG. 2;

FIG. 4 is a spatial representation of the front-end face of the positioning aid in FIG. 3;

FIG. 5 shows a cross section of a secondary preform for a hollow-core fiber comprising a DNANF design, comprising a cladding tube and nested ARE preforms;

FIG. 6 shows a longitudinal section of a first embodiment of a positioning aid for use in the production of the preform in FIG. 5;

FIG. 7 is a spatial representation of the front-end face of the positioning aid in FIG. 6;

FIG. 8 shows a cross section of a secondary preform for a hollow-core fiber comprising an ALIF design, comprising a cladding tube and nested ARE preforms;

FIG. 9 shows a longitudinal section of a positioning aid for use in the production of the preform in FIG. 8;

FIG. 10 is a spatial representation of the front-end face of the positioning aid in FIG. 9;

FIG. 11 shows a front part of a second, multi-part embodiment of a positioning aid for use in the production of the preform in FIG. 5 on the basis of a cross section of the front part for receiving and positioning the primary tubes; and,

FIG. 12 is a spatial representation of the front-end face of the front part of the positioning aid in FIG. 11.

### DETAILED DESCRIPTION

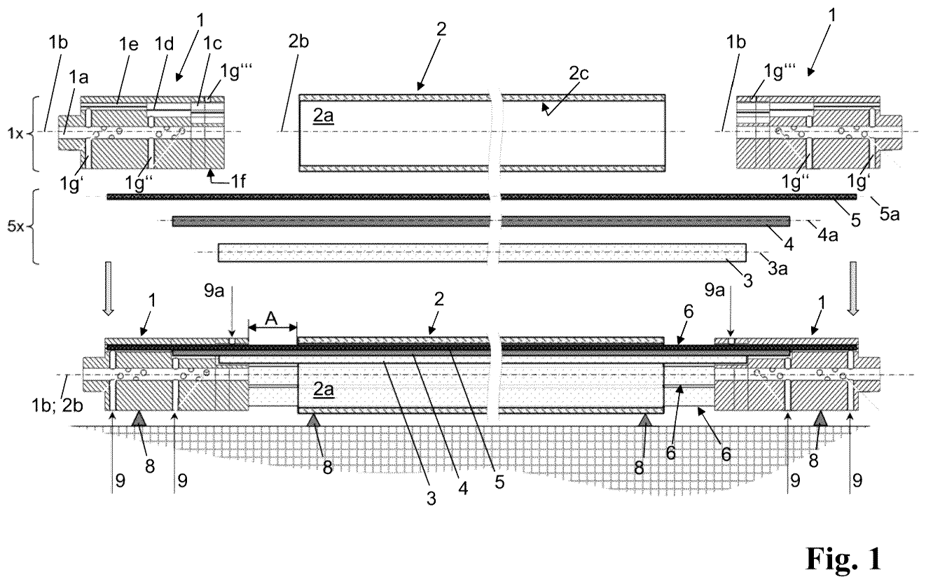

The exploded view in FIG. 1 shows the following in the upper region from left to right and from top to bottom: a left positioning aid 1, a cladding tube 2, a right positioning aid 1, five tertiary tubes 5 comprising the tube longitudinal axes 5a, five secondary tubes 4 comprising the tube longitudinal axes 4a and five primary tubes 3 comprising the tube longitudinal axes 3a. The secondary tubes 4 are 40 mm longer than the primary tubes 3 and the tertiary tubes are 60 mm longer than the secondary tubes 4.

The cladding tube 2 consists of quartz glass. The cladding tube longitudinal axis 2b extends along the inner bore 2a of said cladding tube. The inside of the cladding tube is designated by 2c.

The two positioning aids 1 are made from one piece and consist of graphite. They comprise a continuous central bore 1a with a longitudinal axis 1b, an outer side 1f, a plurality of cylindrical receptacles 1c, 1d, 1e with different opening widths, which are formed in the lateral region and merge into one another in the axial direction, as well as a plurality of transverse bores 1g′, 1g″, 1g′″, which each proceed from the positioning aid outer side 1f and open into one of the cylindrical receptacles 1c, 1d, 1e. The transverse bores 1g′, 1g″, 1g′″ are each designed comprising a screw thread over at least part of their length. The positioning aid 1 will be explained in more detail below on the basis of FIGS. 6 and 7.

In each case, a tertiary tube 5, a secondary tube 4 and a primary tube 3 are combined to form an ARE preform 6, which is designed to produce a hollow-core fiber comprising the DNANF design.

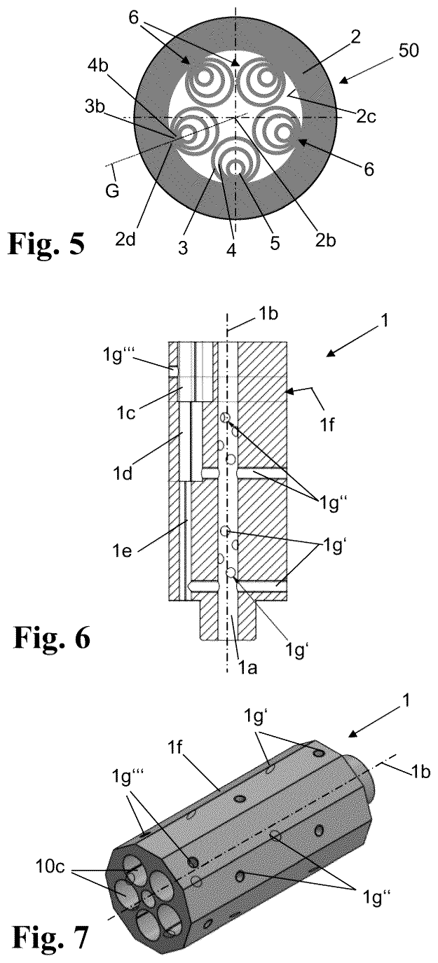

The secondary tube 4 is arranged on the inside of the primary tube 3, and the tertiary tube 5 is arranged on the inside of the secondary tube 4. Five of these ARE preforms 6 are used to produce a preform comprising the DNANF design, as shown in FIG. 5.

In the installation situation shown in the lower region of FIG. 1, the five ARE preforms 6 are arranged on the inside 2c of the cladding tube 2. The longitudinal axes 1b of the positioning aids 1 and the cladding tube longitudinal axis 2b extend coaxially. The cladding tube 2 and the positioning aids 1 are mounted on height-calibrated edges 8 with their longitudinal axes 1b, 2b oriented horizontally. The ARE preforms 6 extend through the inner bore 2a of the cladding tube 2, with both ends projecting into one of the positioning aids 1 and being mounted therein. Only three of the five ARE preforms 6 can be seen, and, for the sake of clarity, the primary tube 3, the secondary tube 4 inserted therein and the tertiary tube 5 inserted therein are only shown in detail for one of said preforms.

Both ends of the primary tubes 3 extend into the front receptacle 1c, which is designed as an elongated hole whose internal dimension is slightly larger than the outer diameter of the primary tube 3. Both ends of the secondary tubes 4 extend into the central receptacle 1d, which is also designed as an elongated hole and whose internal dimension is slightly larger than the outer diameter of the secondary tube 4. Both ends of the tertiary tubes 5 extend into the rear receptacle 1e, which is also designed as an elongated hole and whose internal dimension is slightly larger than the outer diameter of the tertiary tube 5. The starting components (tubes 3, 4, 5) of the ARE preforms 6 are guided into the receptacles in a lateral radial direction, referred to here as rough positioning.

The lengths of the primary tubes 3, secondary tubes 4 and tertiary tubes 5 are graduated such that the primary tubes 3 end in the front receptacles 1c at both ends, the secondary tubes 4 end in the two-sided central receptacles 1d and each protrude slightly from the primary tubes 3, and such that the tertiary tubes 5 end in the two-sided rear receptacles 1c and each protrude slightly from the secondary tubes 4.

Fine adjustment of each individual starting component (3, 4, 5) of the ARE preforms 6 in the lateral radial direction is made possible by set screws which are screwed through the transverse bores 1g′, 1g″, 1g′″ and which can exert a force on each primary tube 3, on each secondary tube 4 and on each tertiary tube 5. The positioning aids 1 are used at both ends of the ARE preforms 6, more precisely in the region of both ends of the respective starting components (3; 4; 5). The set screws are indicated by the directional arrows 9 and 9a. The force can cause a displacement of each of the tubular starting components (3; 4; 5) in a direction that is transverse, in particular in a direction that is perpendicular, to the relevant longitudinal axis of the tube provided that the relevant starting component can still move in this direction and is to be moved in this direction in order to be finely adjusted.

The positioning aids 1 and the cladding tube 2 are not rigidly connected to one another and have a free distance “A” of 30 mm from one another.

After the ARE preforms 6 have been positioned by means of the positioning aids 1 at both ends, they are additionally fixed in this position by local welding.

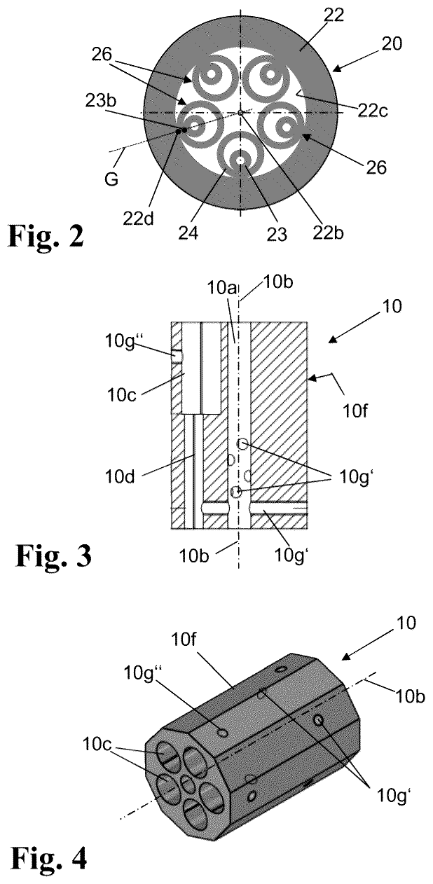

The sketch in FIG. 2 shows a primary preform 20 for a hollow-core fiber in a plan view of one of the preform end faces. The preform 20 has a simple NANF design such that a hollow-core fiber with the simple NANF design can be drawn therefrom.

The preform 20 comprises a cladding tube 22, in the inner bore 22a of which five nested ARE preforms 26 are uniformly distributed and rest against the inside of the cladding tube 22c at peripheral contact points 22d. The ARE preforms 26 each have a primary tube 23 and a secondary tube 24. The secondary tubes 24 rest against the inside of the primary tube at azimuthal contact points 23b. The cladding tube 22 and the tubes (23, 24) of the ARE preforms 26 are made of undoped quartz glass. The cladding tube longitudinal axis 22b and the longitudinal axes of primary tubes 23 and secondary tubes 24 extend in parallel with one another.

The azimuthal contact points 23b on the inside of each of the primary tubes 23 and the peripheral contact points 22d on the inside of the cladding tube 22 each lie on a straight line G, which also extends through the cladding tube center axis 22b.

FIGS. 3 and 4 show one of the two identical positioning aids 10, which were used for supporting the cladding tube 22 and for positioning the five ARE preforms 26 when producing the preform 20 in a similar way to that explained with reference to FIG. 1.

The positioning aid 10 is made from one piece and consists of graphite. It has a continuous central bore 10a with a longitudinal axis 10b, a polygonal outer side 10f (decagon), a plurality of cylindrical receptacles 10c, 10d with different opening widths, which are formed in the lateral region and merge into one another in the axial direction, as well as five transverse bores 10g′ and five transverse bores 10g″, which each proceed from the positioning aid outer side 10f, cross the inner bore 10a and open into one of the cylindrical receptacles 10c, 10d. The polygonal outer side 10f is formed by ten flat sides, the number of which is thus twice as large as the number of ARE preforms 26 to be received.

The five front receptacles 10c are each designed to receive a primary tube 3 (FIG. 1) and the five rear receptacles 10d are each designed to receive a secondary tube 4 (FIG. 1). The cross section of each of the cylindrical receptacles 10c, 10d is an elongated hole, with the long-elongated hole major axis extending in the radial direction with respect to the longitudinal axis 10b. The length ratio of the long and major axes is 1.04.

Each of the transverse bores 10g′, 10g″ are designed comprising a screw thread over at least part of their length and are provided with set screws 9 (FIG. 1). The transverse bores 10g′ extend from a flattened portion of the outer side 10f, through the inner bore 10a and intersect the longitudinal axis 10b of the positioning aid 10. Therefore, these transverse bores 10g′ are distributed over the length of the positioning aid 10 in the region of the rear receptacle 10d. The set screws 9 guided through these transverse bores 10g′ can each exert a force on the outer surface of a secondary tube 4 which—with respect to the longitudinal axes 1a and 2a—acts radially outward. The set screws 9a guided through the transverse bores 10g″ can exert a force on the outer surface of a primary tube 3 which—with respect to the longitudinal axis 10b—acts radially inward. This adjustment option is only provided as an extra. Since each secondary tube 4 directly rests against the inside of a primary tube 3, the force exerted on the secondary tube 4 by means of the set screw 9 can also indirectly move the primary tube 3 outward in the radial direction and thus also cause the primary tube 3 to be finely adjusted in this direction.

The sketch in FIG. 5 shows a primary preform 50 for a hollow-core fiber in a plan view of one of the preform end faces. This has a so-called DNANF design, and therefore a hollow-ore fiber with a DNANF design can be drawn therefrom.

The preform 50 comprises a cladding tube 2, within the inner bore of which five nested ARE preforms 6 are evenly distributed and connected to the inside of the cladding tube at peripheral contact points 2d. The ARE preforms 6 each comprise a primary tube 3, a secondary tube 4 and a tertiary tube 5. The secondary tubes 4 rest against the inside of the primary tube at azimuthal contact points 3b, and the tertiary tubes 5 rest against the inside of the secondary tube at azimuthal contact points 4b. The cladding tube 2 and the tubes (3, 4, 5) of the ARE preforms 6 are made of undoped quartz glass. The longitudinal axes of the tubes extend in parallel with one another.

The azimuthal contact points 3b and 4b on the inside of each of the elongated primary tubes 3 and, respectively, the elongated secondary tubes 4 and the peripheral contact points 2d on the inside 2c of the cladding tube 2 each lie on a straight line G, which also extends through the central cladding tube axis 2b.

FIGS. 6 and 7 each show one of the two identical positioning aids 1, which were used for supporting the cladding tube 2 and for positioning the five ARE preforms 6 when producing the preform 50 in a similar way to that explained in FIG. 1.

The positioning aid 1 is made of graphite. It has a continuous central bore 1a with a longitudinal axis 1b, a polygonal outer side 1f (decagon), a plurality of cylindrical receptacles 1c, 1d, 1e with different opening widths, which are formed in the lateral region and merge into one another in the axial direction, as well as five transverse bores 1g′, five transverse bores 1g″ and five transverse bores 1g′″, which each cross the inner bore 1a starting from the positioning aid outer side 1f and open into one of the cylindrical receptacles 1c, 1d, 1e.

The five front receptacles 1c are each designed to receive a primary tube 3, the five central receptacles 1d are each designed to receive a secondary tube 4, and the five rear receptacles 1e are designed to receive a tertiary tube 5. The cylindrical receptacles 1c, 1d, 1e are each designed as an elongated hole, with the long axis of the elongated hole (long major axis) extending in cross section in the radial direction with respect to the longitudinal axis 1b. The length ratio of the long and major axes is 1.04.

Each of the transverse bores 1g′, 1g″, 1g′″ is designed comprising a screw thread over part of its length and is provided with set screws (FIG. 1). The set screws 9a guided through the transverse bores 1g′″ can exert a force on the outer surface of a primary tube 3 which acts—with respect to the longitudinal axis 1a—radially inward. In contrast, the transverse bores 1g′, 1g″ extend from a flattened portion of the outer side 1f and through the inner bore 1b of the positioning aid 1. These transverse bores 1g′, 1g″ are therefore distributed over the length of the positioning aid 1 in the region of the rear receptacle 1e and the central receptacle 1d, respectively. The set screws 9 guided through the transverse bores 1g′, 1g″ can each exert a force on the outer surface of a secondary tube 4 or on the outer surface of a tertiary tube 5, which force acts—relative to the cladding tube center axis 2a or to the longitudinal positioning aid axis 1a—radially outward, i.e., in the direction of the cladding tube inside 2c.

Since each secondary tube 4 rests directly against the inside of a primary tube 3, the force exerted on the secondary tube 4 by means of the set screw 9 can also move the primary tube 3 outward in the radial direction, thus allowing the primary tube 3 to be finely adjusted in this direction as well. Likewise, because each tertiary tube 5 rests against the inside of a secondary tube 4, the force exerted on the tertiary tube 5 by means of the set screw 9 can also act on the secondary tube 4 and thus indirectly also on the primary tube 3 and cause it to be displaced outward in the radial direction, thus allowing the secondary tube 4 and the primary tube 3 to be finely adjusted in this direction as well.

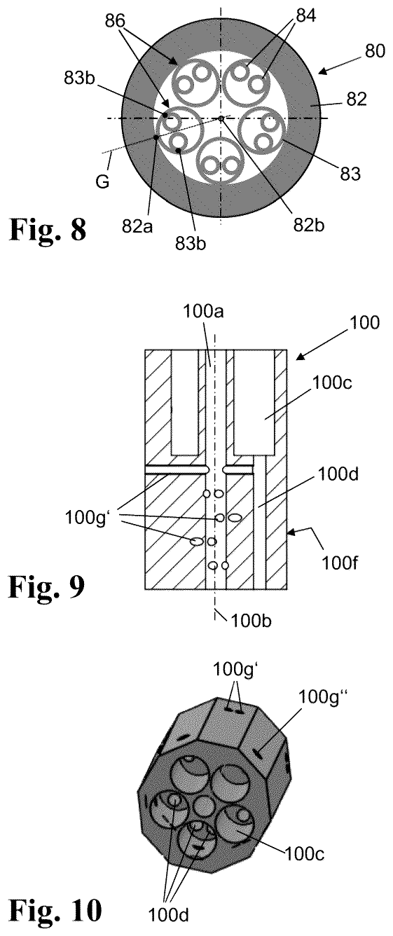

The sketch in FIG. 8 shows a primary preform 80 comprising an ALIF design so that a hollow-core fiber comprising an ALIF design can be drawn therefrom.

The preform 80 consists of a cladding tube 82, on the inside of which five ARE preforms 86 are uniformly distributed. The ARE preforms 86 each comprise a primary tube 83 and two secondary tubes 84 arranged in the primary tube inner bore. The cladding tube 82 and the tubes (83, 84) of the ARE preforms 86 are made of undoped quartz glass. The longitudinal axes of the tubes extend in parallel with one another.

The two azimuthal contact points 83b on the inside of each of the primary tubes 83 are located at both ends and at the same distance from a straight line G which runs through the cladding tube center axis 82b and through the peripheral contact point 82a on the inside of the cladding tube 82.

FIGS. 9 and 10 show one of the two identical positioning aids 100, which were used for supporting the cladding tube 82 and for positioning the five ARE preforms 86 when producing the preform 80 in a similar way to that explained in FIG. 1.

The positioning aid 100 is made of graphite. It has a continuous central bore 100a with a longitudinal axis 100b, a polygonal outer side 100f (decagon), a plurality of cylindrical receptacles 100c, 100d with different opening widths, which are formed in the lateral region and merge into one another in the axial direction.

The five front receptacles 100c are each designed to receive a primary tube 83 and the ten rear receptacles 100d are each designed to receive one of the secondary tubes 84. The cross section of each of the cylindrical receptacles 100c, 100d is designed as an elongated hole, with the long major axis of the elongated hole extending in the radial direction with respect to the longitudinal axis 100b. The length ratio of the long and major axes is 1.04.

Ten transverse bores 100g′, which cross the inner bore 100a starting from the outer side 100f, each open into one of the ten rear cylindrical receptacles 100d. Five further transverse bores 100g″ (FIG. 10), which also start from the outer side 100f, each open into one of the five front cylindrical receptacles 100c.

Each of the transverse bores 100g′, 100g″ are designed comprising a screw thread over at least part of their length and are provided with set screws 9 (FIG. 1). The set screws 9 are inserted from the outer side 100f into the transverse bores 100g′ and 100g″.

The set screws 9, which are guided through the transverse bores 100g′ and cross the inner bore 100a, can each exert a force on the outer surface of a secondary tube 84 which—with respect to the central cladding tube axis 82b or to the longitudinal positioning aid axis 100b—acts radially outward, i.e., in the direction of the cladding tube inside. In contrast, the set screws 9, which are guided through the transverse bores 200g″ and open into the receptacles 100d, can exert a force on the outer surface of the primary tubes 83, the direction of which is directed radially inward toward the longitudinal positioning aid axis 100b. This adjustment option is only provided as an extra. Because each secondary tube 84 directly rests against the inside of a primary tube 83, the force exerted on the secondary tube 84 by means of the set screw 9 from the inside of the primary tube also acts indirectly on the primary tube 83 and can move it outward in the radial direction and thus cause the position of the primary tube 83 to be finely adjusted in this direction as well.

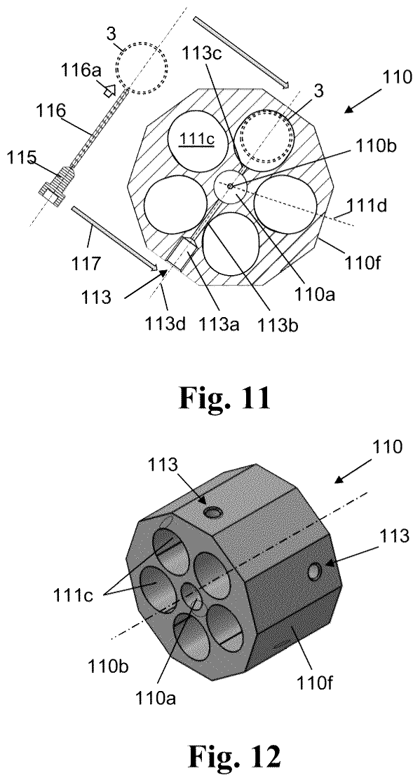

In the embodiments explained thus far, the positioning aids are designed as a single piece. Alternatively, the positioning aids can also be composed of a plurality of segments. This is explained using the example of a two-part positioning aid for the production of a preform 50 with reference to FIGS. 11 and 12 and in conjunction with FIGS. 1 and 5.

These figures show a front piece 110 of the two-part positioning aid for a primary preform 50 (FIG. 5) comprising the DNANF design. In the front piece 110, five front receptacles 111c with an elongated hole cross section are formed and uniformly distributed around the piece longitudinal axis 110b (perpendicularly to the plane of the sheet) and the piece inner bore 110a. The long axis 111d of the elongated hole cross section extends in the radial direction relative to the longitudinal axis 110b. The front receptacles 111c each serve to receive one of five primary tubes 3, as schematically indicated in one case by a dashed circle.

Using only the front piece 110 of the positioning aid, a primary preform for a hollow-core fiber with a simple design can be produced. In this primary preform, only five primary tubes 3 are uniformly distributed around the inside of the cladding tube. More complex designs can be produced by connecting the front piece 110 to a rear piece or to a plurality of rear pieces arranged one behind the other. In the at least one (not shown) rear piece, for example, five receptacles for the secondary tubes 4 and a further five receptacles for the tertiary tubes 5 are formed. The rear piece can be butt-joined to the front piece 110 such that the piece longitudinal axes (110b) are coaxial. However, this is not absolutely necessary if the coaxial course of the piece longitudinal axes (110b) is ensured in some other way, for example by each of the pieces (110) being independently positionable.

The front piece 110 has a decagonal outer contour with ten flat sides. Five transverse bores 113 distributed over the length of the piece extend from the outer side 110f to each of the receptacles 111c. One of them is shown in the cross section in FIG. 11. The transverse bore 113 is characterized by a cross-sectional reduction in the direction of a transverse bore center axis 113d, along which it has a front longitudinal portion 113a, a central longitudinal portion 113b and a rear longitudinal portion 113c. All five transverse bores of the front piece 110 are designed accordingly.

The front longitudinal portion 113a has an internal thread and is designed to receive a screw 115 with an outer diameter of 3 mm. It extends into the front piece 110 of the positioning aid, starting from the outer side 110f, only as deep as is necessary for the screw 115 and internal thread to engage. A thin hollow channel 113b adjoins the front longitudinal portion 113a as a central longitudinal portion (113b) that extends as far as the piece inner bore 110a. Its inner diameter is designed such that a piston 116 with an outer diameter of approximately 0.6 mm can be mounted therein to be axially movable in the direction of the center axis 113d. The rear longitudinal portion 113c extends between the inner bore 110a and the elongated hole receptacle 111c. It has the same inner diameter as the hollow channel 113b.

The block arrows 117 indicate that the screw 115 and the piston 116 are each inserted into one of the transverse bores. The piston 116 has a length that extends from the screw 115 to close to the outer side of the primary tube. By screwing the screw 115 into the internal thread in the front longitudinal portion 113a of the transverse bores 113, the axially movable piston 116 is displaced within the hollow channel 113b in the direction 116a toward the primary tube 3. The piston 116 can thus exert a force which causes the primary tube 3 to move along the center axis 113d and thus against the inner wall of the cladding tube (2).

The reduction in the cross section of the transverse bore 113 has the advantage that the relatively large threaded portion for receiving the screw 115 (in the front longitudinal portion 113a) can be limited to the periphery of the piece 110, where sufficient material volume is available for this purpose. In contrast, only the thin hollow channel 113b runs through the narrow ridge between adjacent primary tube receptacles 111c.

In this embodiment, the screw 115 and piston 116 are designed as separate components. Alternatively, these components can also be made from one piece.

What is claimed is:

1. A method of making an antiresonant hollow-core fiber having a hollow core extending along a fiber longitudinal axis and an inner cladding region surrounding the hollow core, the inner cladding region comprising a plurality of antiresonance elements, the method comprising the steps of:
a) providing a cladding tube having a cladding tube inner bore with a cladding tube inside and a cladding tube center axis,
b) providing a plurality of tubular antiresonance element preforms (abbreviated as ARE preforms), each having a longitudinal tube axis and an outer tube surface,
c) initially positioning the plurality of ARE preforms at peripheral desired positions of the inner surface of the cladding tube by means of a positioning aid, forming a primary preform,
d) thermally stretching the primary preform to form the hollow core fiber or further processing the primary preform to form a secondary preform from which the hollow core fiber is drawn, wherein a positioning aid is used which is equipped with adjusting means that allow a repositioning, which is changed with respect to the initial positioning, of at least some of the ARE preforms.

2. The method according to claim 1, wherein during the repositioning, the ARE preform is displaced in the direction transverse to its tube longitudinal axis.

3. The method according to claim 1, wherein the repositioning is effected by a force acting on the ARE preform, which force comprises a component directed perpendicularly to the cladding tube longitudinal axis and radially outwards.

4. The method according to claim 1, wherein the positioning aid has a longitudinal axis and an outer side, and that the adjusting means comprises a plurality of receptacles, into each of which one end of the ARE preform projects or extends through an ARE preform, and that the adjustment means has transverse bores which each run from the outside of the positioning aid to one of the receiving means and through which a pressure element extends to the outer surface of the tube.

5. The method according to claim 4, wherein the transverse bores are designed as threaded bores and in that at least some of them intersect the longitudinal axis of the positioning aid.

6. The method according to claim 3, wherein the receptacles have an oval cross section or an elongated hole cross section, with a long major axis and with a short major axis, wherein the long major axis extends in each case radially to the positioning aid longitudinal axis.

7. The method according to claim 4, wherein the positioning aid is designed for positioning a number “n” of ARE preforms and that it has at least one flat side in cross-section and preferably has a polygonal outer contour with a number “N” of flat sides, where N=n, or N=2n if “n” is an even number, and where N=2n if “n” is an odd number. gonal outer contour with a number “N” of flat sides, where N=n or N=2n if “n” is an even number, and where N=2n if “n” is an odd number greater than 1.

8. The method according to claim 1, characterized by employing a positioning aid comprising adjustment means for repositioning all of the tubular starting components of the ARE preform, in the case of an interlocked ARE preform comprising a plurality of tubular starting components.

9. The method according to claim 1, characterized by the positioning aid and the cladding tube being axially spaced apart.

10. A method for fabricating an antiresonant hollow-core fiber preform, the hollow-core fiber having a hollow core extending along a fiber longitudinal axis and an inner cladding region surrounding the hollow core, the inner cladding region including a plurality of antiresonance elements, the method comprising the steps of:
a) providing a duct having a duct inner bore with a duct inside surface and a duct center axis,
b) providing a plurality of tubular ARE preforms each having a tube longitudinal axis and a tube outer surface,
c) initially positioning the plurality of ARE preforms at peripheral desired positions of the cladding tube inside by means of a positioning aid, forming a primary preform,
d) optional further processing of the primary preform to form a secondary preform, characterized in that a positioning aid is used which is equipped with adjusting means that enable a repositioning, which is different from the initial positioning, of at least some of the ARE preforms.

11. A positioning aid for use in the manufacture of an antiresonant hollow-core fiber or a preform for an antiresonant hollow-core fiber, which positioning aid has at least a first adjusting means for an initial positioning of at least one inner tube on an inside of at least one outer tube, wherein the positioning aid is provided with at least one second adjusting means which allows a repositioning of the at least one inner tube that is different from the initial positioning.

12. The positioning aid according to claim 11, wherein the positioning aid has a longitudinal axis and an outer side, and in that the at least one first adjustment means comprises a receiver for the inner pipe, and in that the at least one second adjustment means has a transverse bore which runs from the outer side of the positioning aid to the receiver and through which a pressure element extends.

13. The positioning aid according to claim 12, wherein the transverse bore is designed as a threaded bore and in that it intersects the longitudinal axis of the positioning aid.

14. The positioning aid according to claim 12, wherein the receiver has an oval cross section or an elongated hole cross section with a long major axis and with a short major axis, the long major axis running radially to the positioning aid longitudinal axis.

15. The positioning aid according claim 12, wherein the positioning aid is designed for positioning a number “n” of ARE preforms on the inside of a cladding tube, and in cross section has at least one flat side and preferably has a polygonal outer contour with a number “N” of flat sides, where N=n or N=2n if “n” is an even number, and where N=2n if “n” is an odd number greater than 1.
